(19) United States
(12) Patent Application Publication
(10) Pub. No.: US 2003/0028388 A1
(43) Pub. Date: Feb. 6, 2003

(54) Method for managing shipments

(76) Inventor: Nathan H. Jorgenson, Louisville, KY (US)

Correspondence Address: John S Beulick, Armstrong Teasdale LLP, One Metropolitan Square Suite, Suite 2600, St Louis, MO, 63102, US

(21) Appl. No.: 09/742,546

(22) Filed: Dec. 22, 2000

(51) Int. Cl. G06F 17/60

(52) U.S. Cl. 705/1; 705/404; 705/408

(57) ABSTRACT

A method is provided for storing, verifying and updating the shipping of a product using packing slip data that is scanned onto a server where the data can be accessed via the Internet at both the supplier and purchaser locations. The method comprising the steps of inputting packing slip data for a product to be shipped onto a server that is connected to the Internet, storing the information contained on the packing slip onto the server, comparing the information from the stored packing slip to a supplier database on the server, updating the stored packing slip information based on the comparison to the supplier database, printing the updated packing slip from the server, attaching the printed packing slip to the product to be shipped. Once the product is delivered to the purchaser, the purchaser verifies the printed packing slip to the shipped product and inputs exceptions and notations onto the server. This inputted information is then compared to the supplier's database and a modified shipment is prepared, if necessary.

### BACKGROUND OF THE INVENTION

This invention generally relates to a method managing shipment of products, and, more particularly to a method for monitoring, storing and verifying packing slip information via the Internet in relation to the shipment and delivery of a product.

In recent years, the shipment of product by overnight and other forms of package delivery has become embedded within our business culture. These shipments must be verified and logged into inventory on a regular basis. If a shipment is incomplete or defective, the supplying company needs to receive this information in order to make the appropriate corrections in an expedited fashion.

Computerized methods for tracking the shipment of parcels are known in the prior art. One such system is disclosed in U.S. Pat. No. 4,839,813 issued to Hills et al. In accordance with the system disclosed in Hills et al., a user can track and record transactions of various different carriers and can store a file of records relating to the transactions.

However, Hills et al. does not disclose a method for quickly and easily updating the supplier of an error or omission in the actual shipped product. Instead, Hills et al. only allows the user to maintain files relative to shipments made with different carriers. Hills et al. also does not disclose a method for the comparing and sending information regarding a shipment via the Internet.

In shipping goods from a supplier's plant or from a warehouse to a purchaser, there is a necessity for a reliable record of each transaction in order to verify receipt of the product and discover any errors or omissions.

Processing shipment transactions between a supplier and a purchaser has been a manually intensive effort and has experienced little change.

Generally, the shipment transaction process starts when the product is prepared for shipment and a packing slip is created based on the items prepared for shipment. A carrier picks up the goods at the supplier's warehouse dock. The carrier receives a copy of a transaction document, sometimes referred to as a bill of lading (BOL), from the supplier. This type of transaction document includes information associated with the shipment transaction which is used by the supplier and carrier to track the shipment of goods. The carrier transports the goods to the purchaser where the purchaser signs a copy of the BOL to verify receipt of the goods. After the carrier has delivered the goods to the purchaser, the carrier also submits the purchaser's signed copy of the BOL to the carrier's headquarters.

A disadvantage of the prior art systems is the inability to obtain immediate information regarding the status of the shipped product. Since the process is largely conducted manually, it is very difficult to obtain this information in an expedited manner. To learn of the status of the shipped product, there are various manual steps involved. For example, the purchaser will call the supplier to discuss such problems as missing or defective items.

Nothing in the prior art is believed to provide the benefits attendant with the present invention.

Therefore, it would be desirable to provide an improvement which overcomes the inadequacies of the prior art and which is a significant contribution to the advancement of the art.

It would be further desirable to provide a method that allows:

the purchaser to quickly and easily verify the quality and totality of the product that has been received from a supplier;

to update the supplier's database directly through the purchaser and as a result prepare and send a modified shipment from the supplier to the purchaser;

allows the purchaser to quickly and easily update its inventory log based on the received shipment from the supplier.

It would also be desirable to provide a method that allows:

standardization of the format of packing slips;

reduction in errors from manually typing in receipts;

reduction in effort in auditing paper packing slips;

provides suppliers with real-time knowledge of what has been received; and

provides real-time knowledge of what is in-transit.

### BRIEF SUMMARY OF THE INVENTION

Generally speaking, the present invention fulfills the foregoing needs by providing in one aspect thereof a method for managing shipment of a product through the use of the Internet. The method allows for the supplier to input packing slip data for a product to be shipped onto a server that is connected to the Internet. The method further allows for storing the packing slip data in the server. A comparing step allows for comparing the packing slip data to supplier data stored in a database. An updating step allows for updating the stored packing slip data based on the comparison step. A packing slip may then be printed based on the update packing slip data from the server. The printed packing slip is attached to the product to be shipped. Upon receipt, the purchaser verifies the printed packing slip to the product that has been received. If necessary, exceptions and notations may be inputted onto the server by the purchaser.

### BRIEF DESCRIPTION OF THE DRAWINGS

The invention will become more readily apparent from the following description of preferred embodiments thereof shown, by way of example only, in the accompanying drawings wherein:

FIG. 1 illustrates a block diagram of a method in accordance with one aspect of the present invention showing exemplary information flow and product flow;

FIG. 2 is a flow diagram illustrating the steps that the supplier executes to prepare the electronic packing slip of the present invention; and

FIG. 3 is a flow diagram illustrating the steps that the purchaser executes in receiving a shipment linked to the electronic packing slip of the present invention.

### DETAILED DESCRIPTION OF THE INVENTION

The present invention provides a method for storing and verifying the receipt of a product by a purchaser through the use of the Internet.

The following describes the present invention which involves the shipment of a product from a supplier to a purchaser using the Internet to store, verify and update the information relating to the contents of the shipped product.

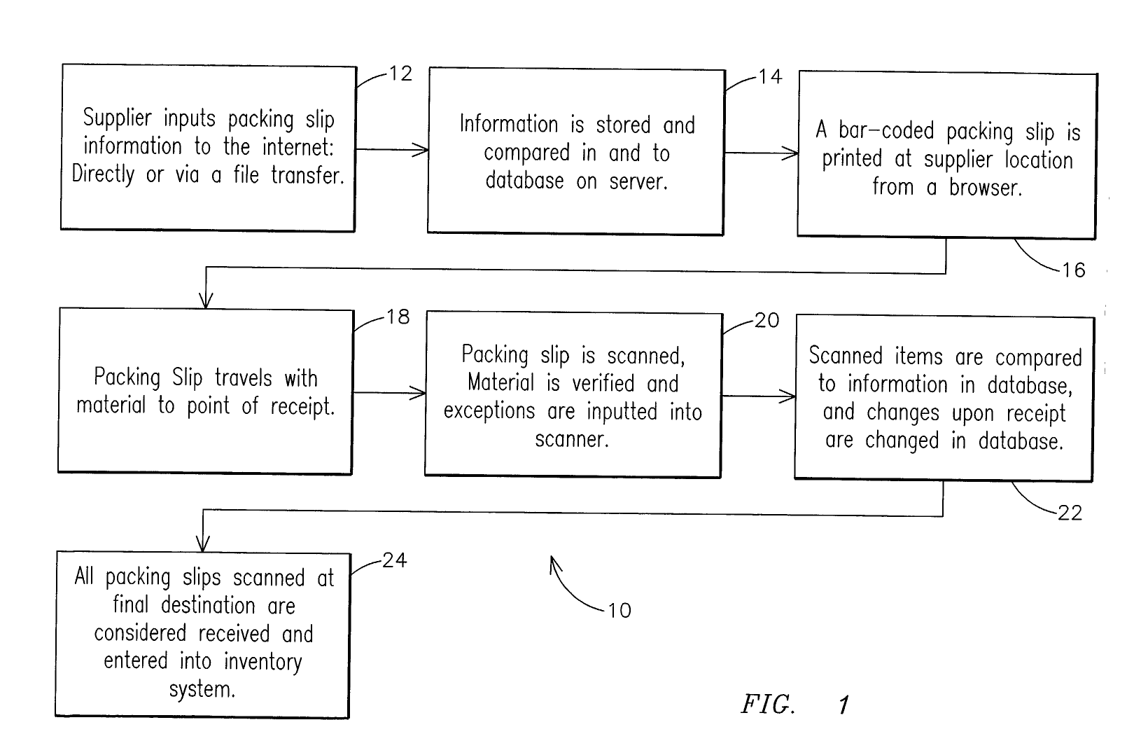

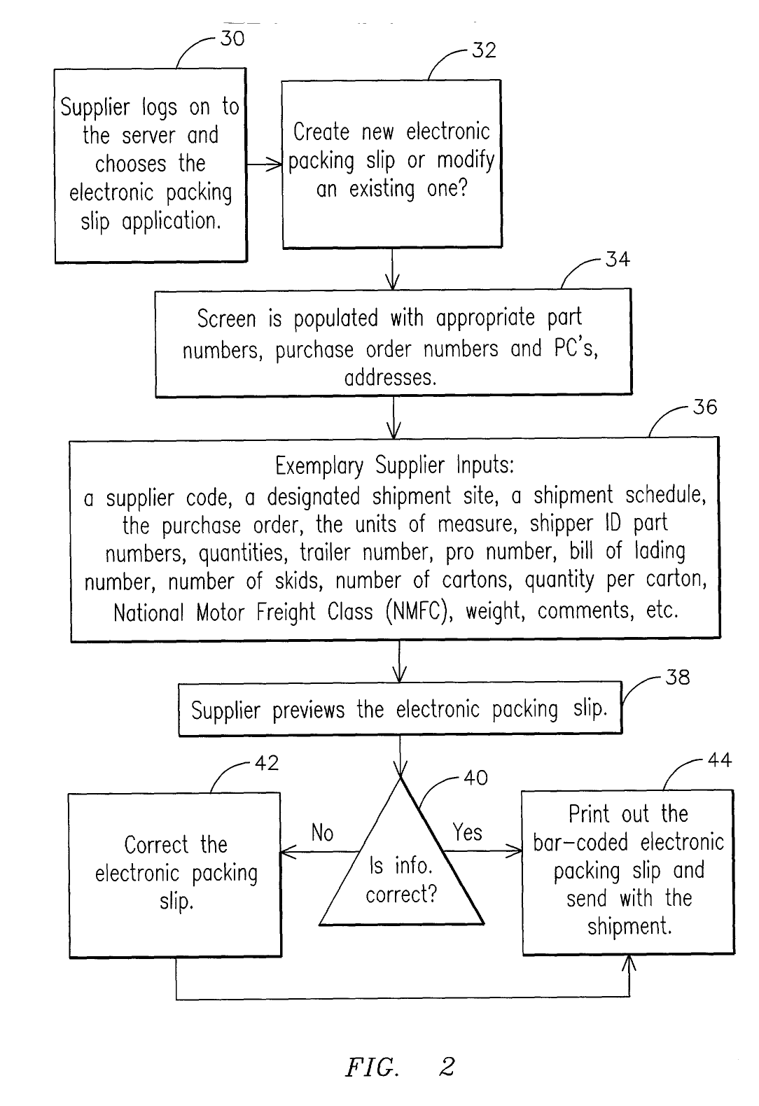

FIG. 1 is a block diagram that illustrates the steps for a supplier to employ an electronic packing slip relating to a product that is to be shipped to a purchaser. The data or information for the electronic packing slip is entered 12 onto a server that communicates with the Internet. The information can be inputted either directly or via a file transfer.

The electronic packing slip information is then stored and compared 14 to respective supplier data as may be stored in a database of the supplier. This comparison allows the supplier to verify inventory to the product that is shipped. In addition, the packing slip information is now available, via the Internet, to the purchaser.

If the supplier is satisfied with the preview, then the supplier can print a hard copy packing slip 16 from the server. In one exemplary embodiment, this hard copy packing slip also contains the information in a bar-coded format. In a preferred embodiment, the barcode is in the form of a Global Unique Identifier (GUID).

Once the hard copy packing slip is printed, the packing slip is attached to the product and shipped with the product to the purchaser 18. Notwithstanding, the supplier can make modifications to the electronic version of the packing slip at any point between when the packing slip was created to when the packing slip is received by the purchaser.

Upon receipt of the shipment, the purchaser scans the bar-coded information on the packing slip and compares this information to the actual product 20. Once the barcode is scanned by a dock person, the scanned data is sent, via the Internet, to the server. The most recent supplier-created version of the packing slip is retrieved from the electronic packing slips database. This electronic packing slip is displayed on the screen of a computer terminal. In a preferred embodiment, a notebook computer is used.

If there is a discrepancy between what has actually been shipped and what appears on the electronic packing slip (a quantity is different, or an additional part was shipped), then the purchaser, enters any exceptions and/or notations to the shipped product into the server 20. Then, the scanned information and the exceptions and/or notations are compared to the information in the supplier's database 22. After comparison, the supplier can prepare a modified shipment which corrects the issues found in the comparison of the data on the server.

At 24, once a packing slip has been scanned and approved at the final destination, the slip is considered received and entered into the database that includes inventory data.

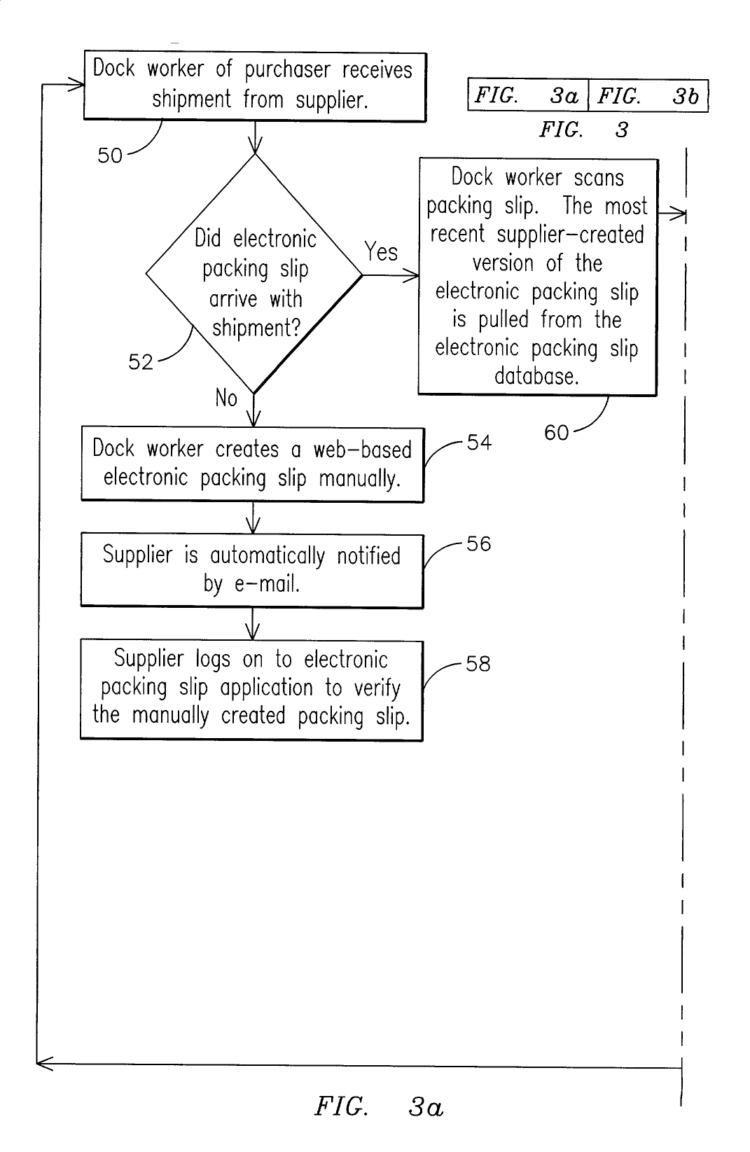

FIG. 2 is a flow diagram illustrating the steps that the supplier executes to prepare the electronic packing slip of the present invention. The supplier begins the process by logging on to the server 30. Once there, the supplier chooses the electronic packing slip application. The supplier will have the choice to create a new electronic packing slip or to modify an existing electronic packing slip 32.

If the supplier chooses to create a new electronic packing slip then the electronic packing slip application will offer appropriate part numbers, purchase order numbers and addresses to the supplier to fill in 34. Next, the supplier creates an electronic packing slip through fields and pull down menus 36 in the electronic packing slip application. For example, the supplier can enter the following information on the electronic packing slip:

a supplier code

a designated shipment site

a shipment schedule

the purchase order associated with the shipment

the units of measure associated with the ordered parts

shipper ID

part numbers

purchase order number

quantities

In addition, there are optional fields that the supplier can use, such as a trailer number, the pro number, the bill of lading number, number of skids, number of cartons, quantity per carton, the hot item checkbox, additional information, National Motor Freight Class (NMFC), Class, weight, comments, etc.

The supplier has the option of customizing the NMFC and Class associated with each part. This option is performed in an administrative screen that lists all the parts of the supplier. The supplier is responsible for filling in the NMFC and Class for each part.

In addition, the supplier has the option of customizing its ship-from address in the administrative screen. For example, the ship-from address can appear on the packing slip, if chosen.

The supplier can save an incomplete electronic packing slip for later retrieval through an assigned name and then finish filling out the form at a later time. Once the electronic packing slip is complete, the supplier can preview the electronic packing slip 38. This allows the supplier an opportunity to double-check the electronic packing slip for any errors 40. If there are errors, the supplier can go back into the electronic packing slip application and modify the electronic packing slip 42.

If the supplier does make modifications to an electronic packing slip with an “open” status, a new revision of that packing slip is created electronically and stored in the electronic packing slip database. Should any changes be made to the electronic packing slip once it has been received by the purchaser, the supplier can notify the purchaser by email of any changes to the packing slip and of any manually created ones. An administrative screen specifies email addresses to which notifications can be sent.

When the supplier is satisfied with the preview, then the supplier can print a hard copy packing slip from the server 44. Once the hard copy packing slip is printed, the packing slip is attached to the product and shipped with the product to the purchaser.

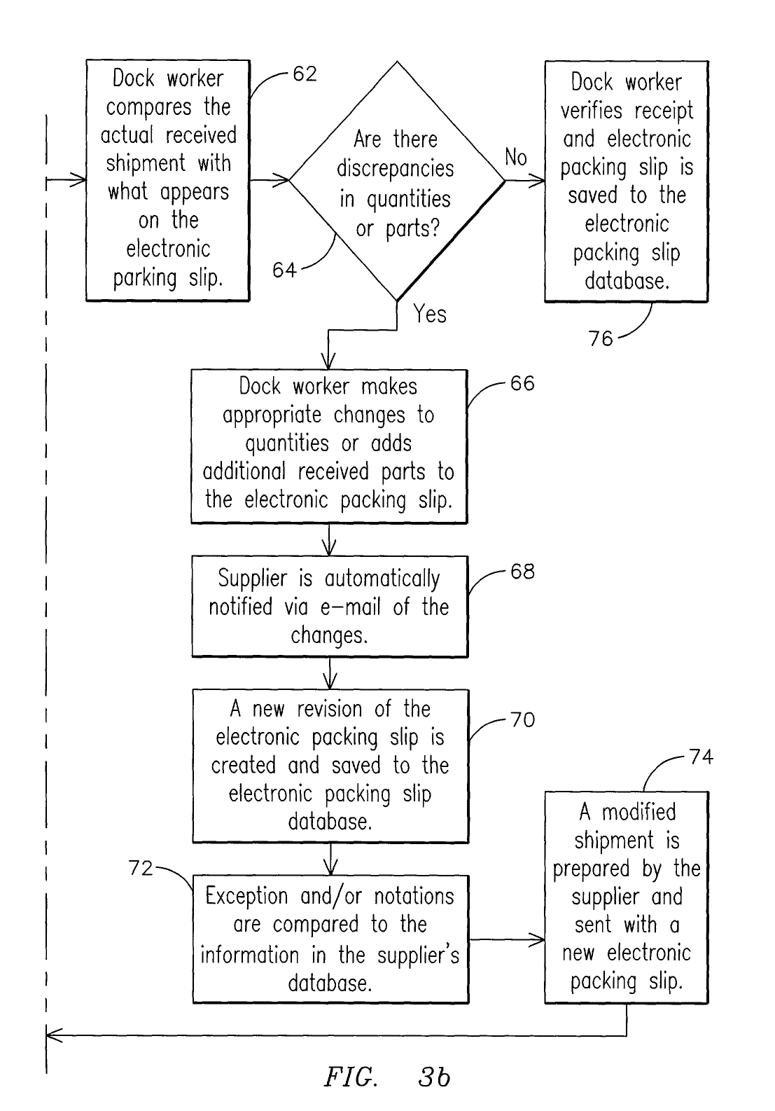

FIG. 3 is a flow diagram illustrating the steps that the purchaser executes in receiving the shipment that has been linked to the electronic packing slip of the present invention.

When a shipment arrives 50 from a supplier, the dock worker checks to see if a hard copy of the electronic packing slip arrived with the shipment 52. If a shipment arrives without an electronic packing slip, the receiving person can create an electronic packing slip using the electronic packing slip application on the server 54. The packing slip information will be mostly typed in by hand. However, part numbers, purchase orders, supplier codes, and units of measure should all be tied together. Once this has been done, an automatic email is sent to the supplier for those parts stating that a manual entry has been created 56. The supplier must log on to the electronic packing slip application to verify the manually created packing slip 58.

Upon receipt of the shipment, the purchaser scans the bar-coded information 60 on the packing slip and compares this information to the actual product 62. Once the barcode is scanned by a dock person, the scanned data is sent, via the Internet, to the server. The most recent supplier-created version of the packing slip is retrieved from the electronic packing slip database. This electronic packing slip is displayed on the screen of a computer terminal.

At this point, the dock worker of the purchaser goes through the shipment and physically counts what has been received 64. The dock worker goes through and verifies each line item and each line item's quantity is the same as what appears on the electronic version of the packing slip. Once the dock worker is done, the packing slip is saved to the electronic packing slip database.

If there is a discrepancy between what has actually been shipped and what appears on the electronic packing slip (a quantity is different, or an additional part was shipped), then the purchaser, enters any exceptions and/or notations to the shipped product into the server 66. The supplier is automatically notified via email of any changes 68. As a result, a new revision of the electronic packing slip is created and saved to the electronic packing slip database 70.

Then, the scanned information and the exceptions and/or notations are compared to the information in the supplier's database 72. After comparison, the supplier can prepare a modified shipment which corrects the issues found in the comparison of the data on the server 74.

Accordingly, once the supplier is notified of any errors or omissions, the process can begin anew. The supplier can prepare assembly of the modified shipment and prepare and print a new bar-coded packing slip which is entered into the server. The modified shipment is sent to the purchaser with the attached new bar-coded packing slip. Then, the purchaser receives the modified shipment and scans the new bar-coded packing slip into the server via the Internet. Again, the purchaser verifies the packing slip to the modified shipment and enters any omissions or issues into the server, via the Internet, for any corrections after comparison to the supplier's database.

Once there are no further discrepancies, the final version of the electronic packing slip is saved in the electronic packing slip database 76.

In addition, the data of both the scanned bar-coded packing slip and the scanned new bar-coded packing slip information can be downloaded from the server to the purchaser's inventory system.

In operation, the present invention allows for verifying and updating the delivery and stocking of product via the Internet.

The present disclosure includes that contained in the appended claims, as well as that of the foregoing description. Although this invention has been described in one exemplary form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

I claim:

1. A method for managing shipment of a product through the use of the Internet, said method comprising:
inputting into a server packing slip data for a product to be shipped;
storing said packing slip data in said server;
comparing said stored packing slip data relative to respective supplier data stored in a database;
updating said stored packing slip data based on said comparison;
printing a packing slip based on said updated packing slip data from said server;
attaching said printed packing slip to the product to be shipped;
verifying said printed packing slip relative to product actually shipped; and
inputting exceptions and/or notations into said server.

2. The method recited in claim 1 wherein said printed packing slip includes bar-coded information.

3. The method recited in claim 2 wherein the verifying step comprises retrieving data from the packing slip by scanning the bar-coded packing slip.

4. The method recited in claim 3, further comprising:
comparing said exceptions and/or notations relative to data stored in said database;
updating said database on said server with said exceptions and/or notations;
printing a new bar-coded packing slip based on said exceptions and/or notations;
attaching said printed new bar-coded packing slip to a modified product to be shipped;
shipping and delivering the modified product;
verifying said printed new bar-coded packing slip to the modified shipped product; and
inputting any new exceptions and notations onto said server.

5. The method according to claim 4 further comprising:
inputting said packing slip information into a purchaser inventory system; and
comparing said packing slip data to a purchase order.

6. A computer-readable medium encoded with computer program code for managing shipment of a product through the use of the Internet, the program code causing a computer to execute a method comprising:
inputting into a server packing slip data for a product to be shipped;
storing said packing slip data in said server;
comparing said stored packing slip data relative to respective supplier data stored in a database;
updating said stored packing slip data based on said comparison;
printing a packing slip based on said updated packing slip data from said server;
attaching said printed packing slip to the product to be shipped;
verifying said printed packing slip relative to product actually shipped; and
inputting exceptions and/or notations into said server.

7. The computer-readable medium of claim 6 wherein said printed packing slip further includes bar-coded information.

8. The computer-readable medium of claim 7 wherein the verifying step comprises retrieving data from the packing slip by scanning the bar-coded packing slip.

9. The computer-readable medium of claim 8 further comprising:
comparing said exceptions and/or notations relative to data stored in said database;
updating said database on said server with said exceptions and/or notations;
printing a new bar-coded packing slip based on said exceptions and/or notations;
attaching said printed new bar-coded packing slip to a modified product to be shipped;
shipping and delivering the modified product;
verifying said printed new bar-coded packing slip to the modified shipped product; and
inputting any new exceptions and notations onto said server.

10. The computer-readable medium of claim 9 further comprising:
inputting said packing slip information into a purchaser inventory system; and
comparing said packing slip data to a purchase order.

11. A web-enabled system for managing shipment of a product, the system comprising:
a module configured to provide a web page including at least a data field to be filled by the supplier with packing slip data indicative of a product to be shipped;
a module configured to store said packing slip data on a server;
a database configured to store inventory data;
a module configured to compare said stored packing slip data relative to said inventory data stored in said database;
a module configured to update said stored packing slip data based on said comparison;
a module configured to print a packing slip based on said updated packing slip data from said server;
attaching said printed packing slip to the product to be shipped;
verifying said printed packing slip relative to product actually shipped; and
a module configured to input exceptions and/or notations into said server.

12. The system of claim 11 wherein said printed packing slip further includes bar-coded information.

13. The system of claim 12 wherein the verifying step comprises retrieving data from the packing slip by scanning the bar-coded packing slip.

14. The system of claim 13 further comprising:
a module configured to compare said exceptions and/or notations relative to data stored in said database;
a module configured to update said database on said server with said exceptions and/or notations;
a module configured to print a new bar-coded packing slip based on said exceptions and/or notations;
attaching said printed new bar-coded packing slip to a modified product to be shipped;
shipping and delivering the modified product;
verifying said printed new bar-coded packing slip to the modified shipped product; and
a module configured to input any new exceptions and notations onto said server.

15. The system of claim 14 further comprising:
a module configured to input said packing slip information into a purchaser inventory system; and
a module configured to compare said packing slip data to a purchase order.
